(19) United States
(12) Patent Application Publication
(10) Pub. No.: US 2023/0042979 A1
(43) Pub. Date: Feb. 9, 2023

(54) SYSTEMS AND METHODS OF HYBRID ALGORITHMS FOR SOLVING DISCRETE QUADRATIC MODELS

(71) Applicant: D-WAVE SYSTEMS INC., Burnaby (CA)

(72) Inventors: Hossein Sadeghi Esfahani, Burnaby (CA); William W. Bernoudy, Vancouver (CA); Mohsen Rahmani, Kirkland, WA (US)

(21) Appl. No.: 17/785,188

(22) PCT Filed: Dec. 14, 2020
(86) PCT No.: PCT/US2020/064875

§ 371 Date: Jun. 14, 2022

Related U.S. Application Data
(60) Provisional application No. 62/951,749, filed on Dec. 20, 2019.

(51) Int. Cl. G06N 10/60

(52) U.S. Cl. CPC G06N 10/60

(57) ABSTRACT

Methods for solving discrete quadratic models are described. The methods compute an energy of each state of each variable based on its interaction with other variables, exponential weights, and normalized probabilities proportional to the exponential weights. The energy of each variable is computed as a function of the magnitude of each variable and a current state of all other variables, exponential weights, the feasible region for each variable, and normalized probabilities, proportional to the exponential weights and respecting constraints. Methods executed via a hybrid computing system obtain two candidate values for each variable; constructs a Hamiltonian that uses a binary value to determine which candidate values each variable should take, then constructs a binary quadratic model based on the Hamiltonian. Samples from the binary quadratic model are obtained via a quantum processor. The methods can be applied to solve resource scheduling optimization problems and/or for side-chain optimization for proteins.

### FIELD

This disclosure generally relates to hybrid algorithms using Gibbs sampling and Cross-Boltzmann updates to solve discrete quadratic models.

### BACKGROUND

### Quantum Processor

A quantum processor may take the form of a superconducting quantum processor. A superconducting quantum processor may include a number of superconducting qubits and associated local bias devices. A superconducting quantum processor may also include coupling devices (also known as couplers) that selectively provide communicative coupling between qubits.

Further details and embodiments of exemplary quantum processors that may be used in conjunction with the present systems and devices are described in, for example, U.S. Pat. Nos. 7,533,068; 8,008,942; 8,195,596; 8,190,548; and 8,421,053.

### Quantum Computation

A quantum computer is a system that makes direct use of at least one quantum-mechanical phenomenon, such as, superposition, tunneling, and entanglement, to perform operations on data. The elements of a quantum computer are qubits. Quantum computers can provide speedup for certain classes of computational problems such as computational problems simulating quantum physics.

### Quantum Annealing

Quantum annealing is a computational method that may be used to find a low-energy state of a system, typically preferably the ground state of the system. The method relies on the underlying principle that natural systems tend towards lower energy states because lower energy states are more stable. Quantum annealing may use quantum effects, such as quantum tunneling, as a source of delocalization to reach an energy minimum.

A quantum processor may be designed to perform quantum annealing and/or adiabatic quantum computation. An evolution Hamiltonian can be constructed that is proportional to the sum of a first term proportional to a problem Hamiltonian and a second term proportional to a delocalization Hamiltonian, as follows:

H_{E}∝A(t)H_{P}+B(t)H_{D}

where H_{E} is the evolution Hamiltonian, H_{P} is the problem Hamiltonian, H_{D} is the delocalization Hamiltonian, and A(t), B(t) are coefficients that can control the rate of evolution, and typically lie in the range [0,1].

In some implementations, a time varying envelope function can be placed on the problem Hamiltonian. A suitable delocalization Hamiltonian is given by:

H_{D}∝−½Σᵢ₌₁^{N}Δᵢσᵢ^{x}

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms.

A common problem Hamiltonian includes a first component proportional to diagonal single qubit terms and a second component proportional to diagonal multi-qubit terms, and may be of the following form:

$${H}_{P} ∝ - \frac{ε}{2} [ {Σ}_{i = 1}^{N} {h}_{i} {σ}_{i}^{z} + {Σ}_{j > i}^{N} {J}_{ij} {σ}_{i}^{z} {σ}_{j}^{z} ]$$

where N represents the number of qubits, σᵢ^{z} is the Pauli z-matrix for the i^{th} qubit, hᵢ and Jᵢⱼ are dimensionless local fields for the qubits, and couplings between qubits, and ε is some characteristic energy scale for H_{P}.

Here, the σᵢ^{z} and σᵢ^{z} σⱼ^{z} terms are examples of “diagonal” terms. The former is a single qubit term and the latter a two qubit term.

Throughout this specification, the terms “problem Hamiltonian” and “final Hamiltonian” are used interchangeably unless the context dictates otherwise. Certain states of the quantum processor are, energetically preferred, or simply preferred by the problem Hamiltonian. These include the ground states but may include excited states.

Hamiltonians such as H_{D} and H_{P} in the above two equations, respectively, may be physically realized in a variety of different ways. A particular example is realized by an implementation of superconducting qubits.

### Sampling

Throughout this specification and the appended claims, the terms “sample”, “sampling”, “sampling device”, and “sample generator” are used.

In statistics, a sample is a subset of a population, i.e., a selection of data taken from a statistical population. In electrical engineering and related disciplines, sampling relates to taking a set of measurements of an analog signal or some other physical system.

In many fields, including simulations of physical systems, and computing, especially analog computing, the foregoing meanings may merge. For example, a hybrid computer can draw samples from an analog computer. The analog computer, as a provider of samples, is an example of a sample generator. The analog computer can be operated to provide samples from a selected probability distribution, the probability distribution assigning a respective probability of being sampled to each data point in the population. The population can correspond to all possible states of the processor, and each sample can correspond to a respective state of the processor.

### Markov Chain Monte Carlo

Markov Chain Monte Carlo (MCMC) is a class of computational techniques which include, for example, simulated annealing, parallel tempering, population annealing, and other techniques. A Markov chain may be described as a sequence of discrete random variables, and/or as a random process where at each time step the state only depends on the previous state.

The Markov chain can be obtained by proposing a new point according to a Markovian proposal process. The new point is either accepted or rejected. If the new point is rejected, then a new proposal is made, and so on. New points that are accepted are ones that make for a probabilistic convergence to the target distribution.

### Gibbs Sampling

Gibbs sampling is a Markov Chain Monte Carlo (MCMC) algorithm that samples from the conditional distribution of one variable of the target distribution, given all of the other variables. As with other MCMC algorithms, Gibbs sampling generates a Markov chain of samples, each of which is correlated with nearby samples.

### Softmax Distribution

The softmax function is a function that takes as input a vector of K real numbers, and normalizes it into a probability distribution consisting of K probabilities proportional to the exponentials of the input numbers. That is, after applying softmax, each component will be in the interval (0,1), and the components will add up to 1, so that they can be interpreted as probabilities. Softmax is often used in neural networks, to map the non-normalized output of a network to a probability distribution over predicted output classes.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

Some classes of problems (e.g., problems with arbitrary variables) cannot be efficiently mapped to a quadratic unconstrained binary optimization (QUBO) problem or an Ising Hamiltonian problem. Thus, those problem require some overhead (e.g., conversion of variables) to be performed on a classical or digital processor to be then solved by a quantum computer. It is therefore desirable to efficiently solve arbitrary variables problems by efficiently mapping the problem to a model (e.g., a binary quadratic model) that can be then solved by a quantum computer. A method of computation in a processor-based system is described. The method may comprises: applying an algorithm to a problem with n arbitrary variables vᵢ; obtaining two candidate values for each arbitrary variable vᵢ from the algorithm; constructing a Hamiltonian that uses a binary value sᵢ to determine which of the two candidate values each arbitrary variable vᵢ should take; constructing a binary quadratic model based on the Hamiltonian; and obtaining samples from the binary quadratic model from a quantum processor as a solution to the problem. A Gibbs sampler may be applied to the problem with n arbitrary variables vᵢ; and two candidate values for each arbitrary variable vᵢ may be obtained from the Gibbs sampler. Applying an algorithm to a problem with n arbitrary variables vᵢ may comprise: for each of the arbitrary variables, computing an energy of each state of the arbitrary variable based on an interaction of the arbitrary variable with other ones of the arbitrary variables; for each of the arbitrary variables, computing a respective exponential weight for the arbitrary variable for each of a number Dᵢ of distinct values of the arbitrary variable; and computing normalized probabilities that each arbitrary variable takes one of the values Dᵢ, proportional to the exponential weights. Applying an algorithm to a problem with n arbitrary variables vᵢ may comprise: for each of the arbitrary variables, computing an energy of the arbitrary variable as a function of a magnitude of the arbitrary variable and a current state of all of the other ones of the arbitrary variables; for each of the arbitrary variables, computing a respective exponential weight for the arbitrary variable for each of a respective number Dᵢ of distinct values of the arbitrary variable; for each of the arbitrary variables, computing a feasible region for the arbitrary variable, the feasible region comprising a set of values that respect a set of constraints; for each of the arbitrary variables, computing a mask for the arbitrary variable at each of the respective number Dᵢ of distinct values; and for each of the arbitrary variables, computing normalized probabilities that collectively represent a probability that the arbitrary variable takes one of the respective number Dᵢ of distinct values of the arbitrary variable, proportional to the exponential weights and the mask. Constructing a binary quadratic model may include defining a new variable xᵢ in terms of sᵢ and the two candidate values and converting the problem to an optimization problem in the space of sᵢ. Constructing a binary quadratic model may include relaxing a constrained binary optimization problem into an unconstrained binary optimization problem using a penalty term; and summing over the two candidate values. The method may further comprise applying an embedding algorithm to the binary quadratic model to define an embedding on the quantum processor before obtaining samples from the binary quadratic model from the quantum processor. The method may further comprise: iteratively repeating until an exit condition is met: applying an algorithm to a problem with n arbitrary variables vᵢ; obtaining two candidate values for each arbitrary variable vᵢ from the algorithm; constructing a Hamiltonian that uses a binary value sᵢ to determine which of the two candidate values each arbitrary variable vᵢ should take; constructing a binary quadratic model based on the Hamiltonian; obtaining samples from the binary quadratic model from the quantum processor; and integrating the samples into the problem. The method may further comprise determining whether an exit condition has been met. The exit condition may include determining whether a measure representative of a quality assessment of the arbitrary variables is satisfied. The problem may be a resource scheduling problem. A processor-based system, comprising at least one classical processor, is operable to perform any of the methods above. The processor-based system may comprise a quantum processor communicatively coupled to the at least one classical processor.

Protein design problems can be formulated as combinatorial optimization problems This optimization problem may be solved using a branch and bound algorithm and/or simulated annealing. The simulated annealing method uses Metropolis proposals; however, as the number of cases in a categorical distribution increases, the use of Metropolis proposals become inefficient; thus, leading to long computational time that render these methods inefficient for complex problems. The present disclosure describes systems and methods useful in improving computational efficiency which may, for example, be used in efficiently performing protein side-chain optimization. A method of operation in a processor-based system to compute a softmax distribution of an input problem having n variables is described. Each variable takes a respective number Dᵢ of distinct values. The method comprises: for each variable of the input problem, computing an energy of each state of the variable of the input problem based in an interaction of the respective variable with other ones of the variables; for each variable of the input problem, computing respective exponential weights for the variable at each of the respective number Dᵢ of distinct values of the variable; for each variable of the input problem, computing normalized probabilities that collectively represent a probability that the variable takes one of the respective number Dᵢ of distinct values of the variable, proportional to the exponential weights; and obtaining a plurality of samples from the number of normalized probabilities. A plurality of samples may be obtained from the normalized probabilities via Inverse Transform Sampling. The input problem may be a protein side-chain optimization problem. The method may further comprise: iteratively repeating until an exit condition is met: for each variable of the input problem, computing an energy of each state of the variable based an interaction of the respective variable with other ones of the variables; for each variable of the input problem, computing a respective number of exponential weights for the variable at each of the respective number Dᵢ of distinct values of the variable; for each variable of the input problem, computing normalized probabilities that collectively represent a probability that the variable takes one of the respective number Dᵢ of distinct values of the variable, proportional to the exponential weights; obtaining a plurality of samples from the normalized probabilities; and integrating the plurality of samples into the input problem. The method may further comprise determining whether an exit condition has been met. The exit condition may include determining whether a measure representative of a quality assessment of the variables is satisfied. A processor-based system, comprising at least one classical processor, is operable to execute any of the methods above.

Integer problems are commonly solved using tree-based algorithms, such as Branch and Bound, or, for example, Dead-End-Elimination (DEE). Under certain circumstances, integer problems may be solved by relaxing the integer variables to continuous ones; however, relaxing the variables does not guarantee finding an optimal solution in the feasible space. Additionally, many current solvers do not scale well when the problem size increases; thus, resulting in a very long computation time that may not be suitable for all applications. A method of operation in a processor-based system to compute a softmax distribution of an input problem having n variables is described. Each variable takes a respective number Dᵢ of distinct values. The method comprises: for each variable of the input problem, computing an energy of the variable of the input problem as a function of a magnitude of the variable and a current state of all other ones of the variables; for each variable of the input problem, computing a number of exponential weights for the variable at each of the respective number Dᵢ of distinct values of the variable; for each variable of the input problem, computing a feasible region for the variable, the feasible region comprising a set of values that respect a set of constraints; for each variable of the input problem, computing a mask for the variable at each of the respective number Dᵢ of distinct values of the variable; for each variable of the input problem, computing a number of normalized probabilities that represent a probability that the variable takes one of the respective number Dᵢ of distinct values of the variable, proportional to the exponential weights and the mask; and obtaining a plurality of samples from the number of normalized probabilities. The input problem may be a constraint quadratic integer problem. The plurality of samples from the number of normalized probabilities may be obtained via Inverse Transform Sampling. The method may further comprise: iteratively repeating until an exit condition is met: for each variable of the input problem, computing an energy of the variable of the input problem as a function of a magnitude of the variable and a current state of all the other ones of the variables; for each variable of the input problem, computing a respective number of exponential weights for the variable at each of the respective number Dᵢ of distinct values of the variable; for each variable of the input problem, computing a feasible region for the variable, the feasible region comprising a set of values that respect a set of constraints; for each variable of the input problem, computing a mask for the variable at each of the respective number Dᵢ of distinct values of the variable; for each variable of the input problem, computing a number of normalized probabilities that the variable takes one of the respective number Dᵢ of distinct values of the variable, proportional to the exponential weights and the mask; obtaining a plurality of samples from the normalized probabilities; and integrating the plurality of samples into the input problem. The method may further comprise determining whether an exit condition has been met. An exit condition may include determining whether a measure representative of a quality assessment of the variables is satisfied. A processor-based system, comprising at least one classical processor, is operable to execute any of the methods above.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of an example hybrid computing system comprising a quantum processor and a classical processor.

FIG. 2 is a flow diagram of an example method of operation of a computing system for sampling from the softmax distribution over cases of a categorical distribution.

FIG. 3 is a flow diagram of an example iterative method of operation of a computing system for sampling from the softmax distribution over cases of a categorical distribution.

FIG. 4 is a flow diagram of an example method of operation of a computing system for sampling from the softmax distribution over cases of a categorical distribution with constraints.

FIG. 5 is a flow diagram of an example iterative method of operation of a computing system for sampling from the softmax distribution over cases of a categorical distribution with constraints.

FIG. 6 is a flow diagram of an example method of operation of a hybrid computing system using cross-Boltzmann updates.

FIG. 7 is a flow diagram of an example iterative method of operation of a hybrid computing system using cross-Boltzmann updates.

FIG. 8 is a flow diagram of an example method of operation of a hybrid computing system for sampling from the softmax distribution over cases of a categorical distribution and using cross-Boltzmann updates.

FIG. 9 is a flow diagram of an example iterative method of operation of a hybrid computing system for sampling from the softmax distribution over cases of a categorical distribution and using cross-Boltzmann updates.

FIG. 10 is a flow diagram of an example method of operation of a hybrid computing system for sampling from the softmax distribution over cases of a categorical distribution using constraints and using cross-Boltzmann updates.

FIG. 11 is a flow diagram of an example iterative method of operation of a hybrid computing system for sampling from the softmax distribution over cases of a categorical distribution using constraints and using cross-Boltzmann updates.

FIG. 12 is a flow diagram of an example method of operation of a hybrid computing system for optimizing resource scheduling.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

Throughout this specification and the appended claims, the terms ‘sample’, ‘sampling’, ‘sample generator’ are intended to have their corresponding meaning in the fields of statistics and electrical engineering. In statistics, a sample is a subset of a population, for example an individual datum, data point, object, or a subset of data, data points or objects. In electrical engineering, sampling refers to collecting a plurality of measurements of a physical system, for example an analog signal.

A hybrid computing system can draw samples from an analog processor. The analog processor can be configured to provide samples from a statistical distribution, thus becoming a sample generator. An example of a processor that can be operated as a sample generator is a quantum processor designed to perform quantum annealing, where each sample corresponds to a state of the processor and the population corresponds to all possible states of the processor.

The headings and Abstract of the Disclosure provided herein are for convenience only and do not interpret the scope or meaning of the implementations.

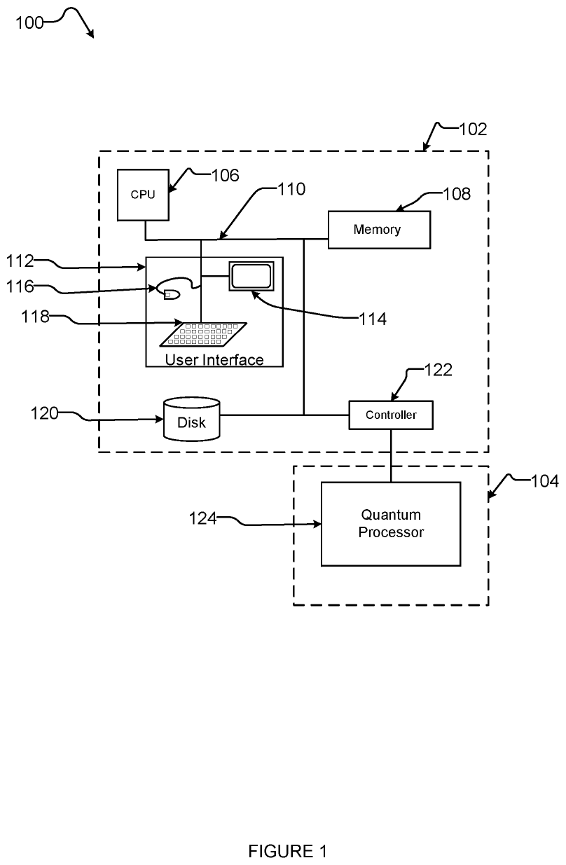

FIG. 1 illustrates a hybrid computing system 100 including a classical computer 102 coupled to a quantum computer 104. The example classical computer 102 includes a digital processor (CPU) 106 that may be used to perform classical digital processing tasks, and hence is denominated herein and in the claims as a classical processor.

Classical computer 102 may include at least one digital processor (such as central processor unit 106 with one or more cores), at least one system memory 108, and at least one system bus 110 that couples various system components, including system memory 108 to central processor unit 106. The digital processor may be any logic processing unit, such as one or more central processing units (“CPUs”), graphics processing units (“GPUs”), digital signal processors (“DSPs”), application-specific integrated circuits (“ASICs”), programmable gate arrays (“FPGAs”), programmable logic controllers (PLCs), etc.

Classical computer 102 may include a user input/output subsystem 112. In some implementations, the user input/output subsystem includes one or more user input/output components such as a display 114, mouse 116, and/or keyboard 118.

System bus 110 can employ any known bus structures or architectures, including a memory bus with a memory controller, a peripheral bus, and a local bus. System memory 108 may include non-volatile memory, such as read-only memory (“ROM”), static random-access memory (“SRAM”), Flash NANO; and volatile memory such as random access memory (“RAM”) (not shown).

Classical computer 102 may also include other non-transitory computer or processor-readable storage media or non-volatile memory 120. Non-volatile memory 120 may take a variety of forms, including: a hard disk drive for reading from and writing to a hard disk, an optical disk drive for reading from and writing to removable optical disks, and/or a magnetic disk drive for reading from and writing to magnetic disks. The optical disk can be a CD-ROM or DVD, while the magnetic disk can be a magnetic floppy disk or diskette. Non-volatile memory 120 may communicate with the digital processor via system bus 110 and may include appropriate interfaces or controllers 122 coupled to system bus 110. Non-volatile memory 120 may serve as long-term storage for processor- or computer-readable instructions, data structures, or other data (sometimes called program modules) for classical computer 102.

Although classical computer 102 has been described as employing hard disks, optical disks and/or magnetic disks, those skilled in the relevant art will appreciate that other types of non-volatile computer-readable media may be employed, such magnetic cassettes, flash memory cards, Flash, ROMs, smart cards, etc. Those skilled in the relevant art will appreciate that some computer architectures employ volatile memory and non-volatile memory. For example, data in volatile memory can be cached to non-volatile memory, or a solid-state disk that employs integrated circuits to provide non-volatile memory.

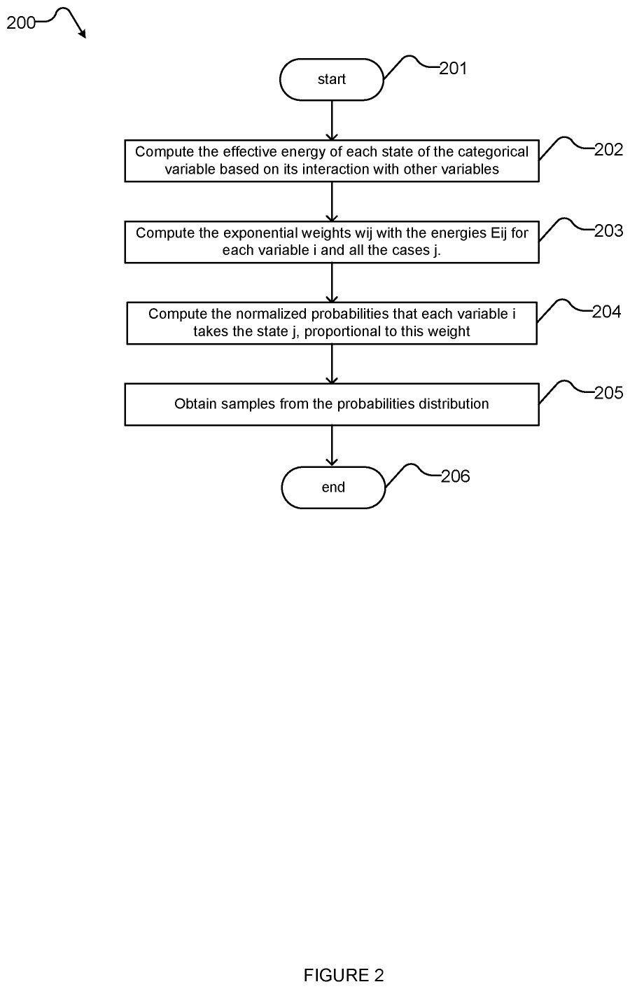

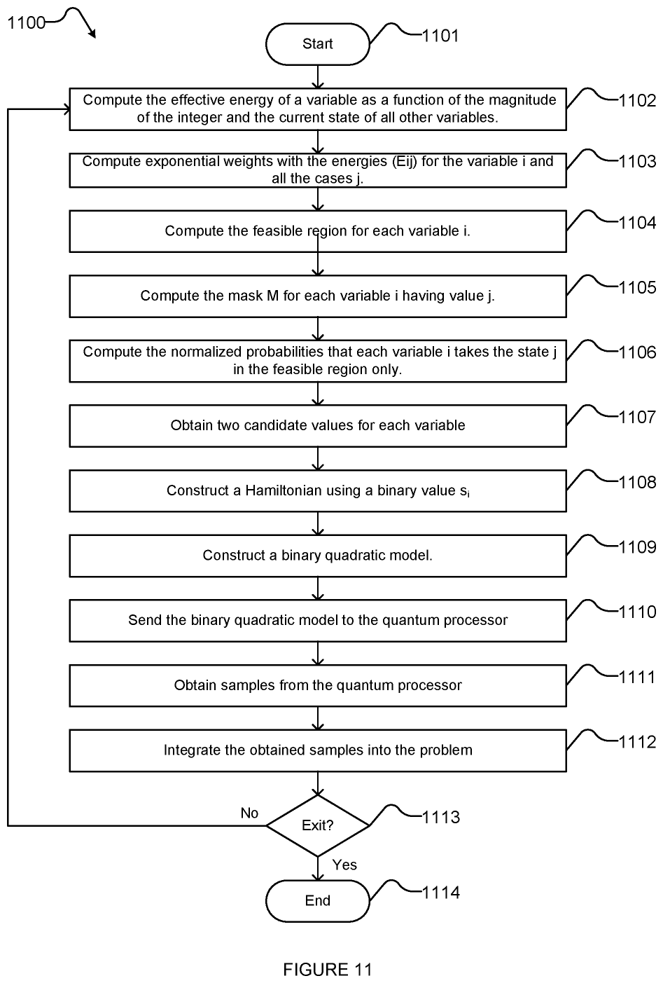

Various processor- or computer-readable instructions, data structures, or other data can be stored in system memory 108. For example, system memory 108 may store instruction for communicating with remote clients and scheduling use of resources including resources on the classical computer 102 and quantum computer 104. For example, the system memory 108 may store processor- or computer-readable instructions, data structures, or other data which, when executed by a processor or computer causes the processor(s) or computer(s) to execute one, more or all of the acts of the methods 200 (FIG. 2) through 1100 (FIG. 11).

In some implementations system memory 108 may store processor- or computer-readable calculation instructions to perform pre-processing, co-processing, and post-processing to quantum computer 104. System memory 108 may store at set of quantum computer interface instructions to interact with the quantum computer 104.

Quantum computer 104 may include one or more quantum processors such as quantum processor 124. The quantum computer 104 can be provided in an isolated environment, for example, in an isolated environment that shields the internal elements of the quantum computer from heat, magnetic field, and other external noise (not shown). Quantum processor 124 includes programmable elements such as qubits, couplers and other devices. In accordance with the present disclosure, a quantum processor, such as quantum processor 124, may be designed to perform quantum annealing and/or adiabatic quantum computation. Examples of quantum processors are described in U.S. Pat. No. 7,533,068.

Proteins are made of amino-acids, a group of naturally occurring small molecules, and the primary structure of a protein is determined by the sequence of amino-acids. The secondary and tertiary structure of a protein is determined by the 3D structure of the folded protein influenced by electrostatic forces (e.g., Van der Waals, salt bridge, hydrogen bond, dipole-dipole, . . . ), where protein folding is the physical process by which a protein chain acquires its native 3-dimensional structure. Therefore, the problem of protein folding can be summarized as determining the tertiary structure of a protein, given a sequence of amino-acids. The inverse problem, protein design, is the problem of finding the sequence of amino-acids that form a desired folded structure with desired properties. Examples of properties that may be desired include pharmacokinetic, binding, thermal stability, function, flexibility, developability, and/or manufacturability.

Side-chain optimization is a part of protein design that formulates a combinatorial optimization problem to find a sequence of amino acids and its optimal configuration that minimizes the energy of some objective function. Side-chain optimization is at the heart of computational peptide design, having applications in the biochemical and pharmaceutical industry. Side-chain optimization is well represented as a combinatorial optimization problem. This optimization problem may be solved using a branch and bound algorithm and/or simulated annealing. An example of an algorithm used for side-chain optimization is Dead-End-Elimination (DEE). The simulated annealing method uses Metropolis proposals in which a change in the categorical variables is proposed and then the acceptance ratio is measured. However, as the number of cases in a categorical distribution increases, the use of Metropolis proposals become inefficient; thus, leading to long computational time that render these methods inefficient for complex problems.

The present disclosure describes systems and methods useful in improving computational efficiency which may, for example, be used in efficiently performing protein side-chain optimization. A classical computer can use Markov Chain Monte Carlo (MCMC) methods (such as, for example, simulated annealing, parallel tempering and population annealing), replacing Metropolis proposal moves by Gibbs sampling.

A side-chain optimization problem may be expressed in terms of

$$H = {\sum }_{i , j} {h}_{i}^{j} {x}_{i}^{j} + {\sum }_{ikjl} {J}_{ik}^{jl} {x}_{i}^{j} {x}_{k}^{l} \qquad ( 1 )$$

where a variable xᵢ can take Dᵢ values or states:

Σⱼ₌₁^{D}^{ᵢ}xᵢ^{j}=1 (2)

i=1, . . . ,N (3)

j=1, . . . ,Dᵢ (4)

xᵢ^{j}∈{0,1} (5)

At any given stage of the MCMC method, the Metropolis proposal moves are replaced by Gibbs sampling. The effective energy of each state of the variable xᵢ is computed based on its interaction with other variables. The energies E(xᵢ^{j}):

$$E ( {x}_{i}^{j} ) = {h}_{i}^{j} + {\sum }_{k} {J}_{ik}^{jm} \qquad ( 6 )$$

for the variable xᵢ and all the cases j=(1, 2, . . . , Dᵢ) are used to computed exponential weights:

wᵢⱼ=e^{-E(x}^{ᵢ}^{^{j}}⁾ (7)

The probability that a variable xᵢ takes state j is proportional to weight wᵢⱼ. This probability is known as the softmax probability distribution. To obtain samples from the probability distribution, thus obtaining samples of the state of a variable xᵢ^{j}, the weights are normalized:

$${p}_{ij} = \frac{{e}^{- β E ( {x}_{i}^{j} )}}{{Σ}_{j = 1}^{{D}_{i}} {e}^{- β E ( {x}_{i}^{j} )}} \qquad ( 8 )$$

where β is the inverse temperature at which the sampling is performed.

Samples may be obtained from the softmax distribution of EQ (6) with standard algorithms or methods, for example Inverse Transform Sampling.

The obtained samples may be further refined by a quantum computer, for example as part of a hybrid algorithm that uses cluster contractions. Cluster contraction hybrid algorithms are disclosed in more details in US Patent Application Publication No. 20200234172.

FIG. 2 is a flow diagram of an example method 200 of operation of a computing system for sampling from the softmax distribution over cases of a categorical distribution. Method 200 may be executed on a hybrid computing system comprising at least one digital or classical processor and a quantum processor, for example hybrid computing system 100 of FIG. 1, or by a classical computing system comprising at least one digital or classical processor.

Method 200 comprises acts 201 to 206; however, a person skilled in the art will understand that the number of acts illustrated is an example, and, in some implementations, certain acts may be omitted, further acts may be added, and/or the order of the acts may be changed.

Method 200 starts at 201, for example in response to a call from another routine.

At 202, the digital processor computes the effective energies E(xᵢ^{j}) of an input problem having n categorical variables. The energies E(xᵢ^{j}) (EQ 6) are computed for each state j=1, . . . , Dᵢ of the categorical variable xᵢ, i=1, . . . , n, based on the interaction of variable xᵢ with other variables. The problem may be received as part of a set of inputs at 201. The problem may, for example, be a protein side-chain optimization problem.

At 203, the digital processor computes the exponential weights wᵢⱼ (EQ 7) for all the cases j of the variable xᵢ.

At 204, the digital processor computes the normalized probabilities pᵢⱼ (EQ 8) that each variable xᵢ takes the state j, proportional to the weights wᵢⱼ computed at 203.

At 205, the digital processor obtains samples from the probability distribution pᵢⱼ, for example using Inverse Transform Sampling.

At 206, method 200 terminates, until it is, for example, invoked again.

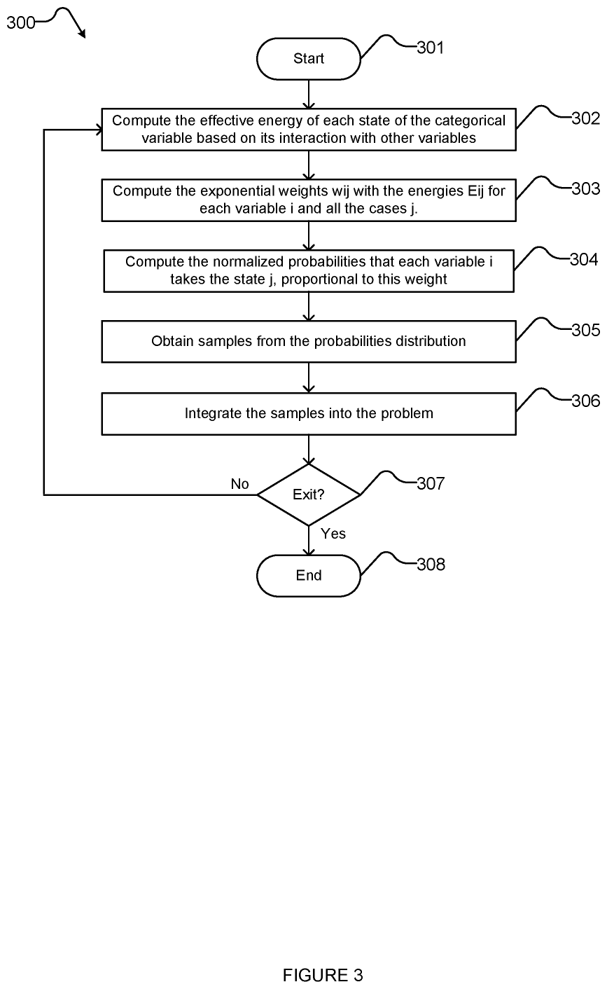

FIG. 3 is a flow diagram of an example iterative method 300 of operation of a computing system for sampling from the softmax distribution over cases of a categorical distribution. Method 300 may be executed on a hybrid computing system comprising at least one digital or classical processor and a quantum processor, for example hybrid computing system 100 of FIG. 1, or by a classical computing system comprising at least one digital or classical processor.

Method 300 comprises acts 301 to 308; however, a person skilled in the art will understand that the number of acts illustrated is an example, and, in some implementations, certain acts may be omitted, further acts may be added, and/or the order of the acts may be changed.

Method 300 starts at 301, for example in response to a call from another routine.

At 302, the digital processor computes the effective energies E(xᵢ^{j}) of an input problem having n categorical variables. The energies E(xᵢ^{j}) (EQ 6) are computed for each state j=1, . . . , Dᵢ of the categorical variable xᵢ, i=1, . . . , n, based on the interaction of variable xᵢ with other variables. The input problem may be received as part of a set of input at 301. The problem may, for example, be a protein side-chain optimization problem.

At 303, the digital processor computes the exponential weights wᵢⱼ (EQ 7) for all the cases j of the variable xᵢ.

At 304, the digital processor computes the normalized probabilities pᵢⱼ (EQ 8) that each variable i takes the state j, proportional to the weights wᵢⱼ computed at 303.

At 305, the digital processor obtains samples from the probability distribution pᵢⱼ, for example using Inverse Transform Sampling.

At 306, the digital processor integrates the samples obtained at 305 into the input problem of 302.

At 307, the digital processor checks if an exit condition has been met. If an exit condition has been met, control passes to 308, otherwise to 302, where the effective energies E(xᵢ^{j}) are computed again, according to EQ (6), on the problem with the integrated samples. An exemplary exit condition may be a determination that a measure or a parameter representative of the quality of the variables is satisfied. An example of a measure of a quality of the variables is the energy of the variables. The determination may, for example, be based on an assessment of the variables, the assessment performed by the digital processor.

At 308 method 300 terminates, until it is, for example, invoked again.

Constraint Integer problems are mathematical optimization or feasibility problems in which some or all of the variables are restricted to be integers and must respect a set of constraints. Integer problems are commonly solved using tree-based algorithms, such as Branch and Bound, or, for example, Dead-End-Elimination (DEE). Under certain circumstances, integer problems may be solved by relaxing the integer variables to continuous ones; however, relaxing the variables does not guarantee finding an optimal solution in the feasible space. Additionally, many current solvers do not scale well when the problem size increases; thus, resulting in a very long computation time that may not be suitable for all applications.

The present disclosure describes systems and methods for solving constraint quadratic integer problems using a computing system, for example hybrid computing system 100 of FIG. 1, comprising at least one classical or digital computer and a quantum computer, or by a classical computing system comprising at least one digital or classical computer. The classical, or digital, computer can use Markov Chain Monte Carlo (MCMC) methods (such as, for example, simulated annealing, parallel tempering and population annealing), replacing Metropolis proposal moves by Gibbs sampling with constraints.

The effective energy E of an integer variable xᵢ can be computed by the digital processor as a function of the magnitude the integer and the current state of all other variables:

$$E ( {x}_{i} ) = ( {h}_{i} + {\sum }_{( i , j ) ∈ E} {Q}_{i , j} {x}_{j} ) {x}_{i} \qquad ( 9 )$$

where hᵢ is the bias on variable xᵢ, Q_{i,j} is the pairwise interaction of the two variables xᵢ and xⱼ.

The energies Eₓ_{ᵢ} for all the variables xᵢ and all the cases, or values, j are used to compute exponential weights:

wₓ_{ᵢ}=e^{-E(x}^{ᵢ₎} (10)

The probability that a variable xᵢ takes the value j is proportional to the weight wₓ_{ᵢ} (EQ 10). This probability is known as the softmax probability distribution. To obtain samples from the probability distribution, thus to obtain samples of the state of a variable xᵢ, the weights are normalized:

$$p ( {x}_{i} ) = \frac{{e}^{- E ( {x}_{i} )}}{{Σ}_{{x}_{i} = 1}^{{D}_{i}} {e}^{- E ( {x}_{i} )}} \qquad ( 11 )$$

where Dᵢ is the number of possible values for variable xᵢ.

Samples may be obtained from the softmax distribution with standard algorithms or methods, for example Inverse Transform Sampling. However, sampling from the probability distribution p(xᵢ) of EQ 11 will results in a violation of one or more of the constraints of the problem; thus, it will not provide a solution to the constraint quadratic integer problem of interest.

Assuming a constraint C can be expressed as

$${\sum }_{i ∈ S} {x}_{i} < C \qquad ( 12 )$$

were S denotes the set of variables that must respect constraint C, the feasible region for a variable xᵢ is

$${x}_{i}^{max} = C - {\sum }_{j ∈ S , j \neq i} {x}_{j} \qquad ( 13 )$$

The mask Mⱼ of a variable xᵢ can be defined as the binary value of

Mⱼ=(xᵢ=j)≤xᵢ^{max} (14)

Therefore, the probability that a variable xᵢ takes the value j in the feasible region only is:

$${p}_{ij} = \frac{{M}_{j} {e}^{- {E}_{ij}}}{{Σ}_{J - 1}^{{D}_{i}} {M}_{j} {e}^{- {E}_{ij}}} \qquad ( 15 )$$

Samples may be obtained from the above probability distribution (EQ 15), for example, using Inverse Transform Sampling.

The obtained samples may be further refined by a quantum computer, for example as part of a hybrid algorithm that uses cluster contractions. Cluster contraction hybrid algorithms are disclosed in more details in US Patent Application Publication No. 20200234172.

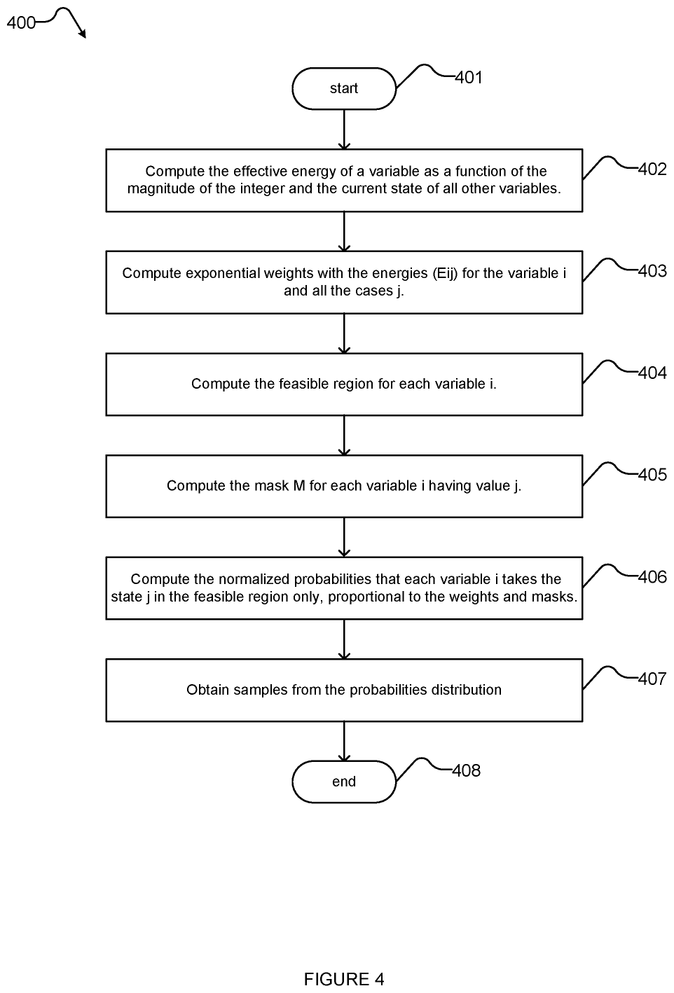

FIG. 4 is a flow diagram of an example method 400 of operation of a computing system for sampling from the softmax distribution over cases of a categorical distribution using constraints. Method 400 may be executed on a hybrid computing system comprising at least one digital or classical processor and a quantum processor, for example hybrid computing system 100 of FIG. 1, or by a classical computing system comprising at least one digital or classical processor.

Method 400 comprises acts 401 to 408; however, a person skilled in the art will understand that the number of acts illustrated is an example, and, in some implementations, certain acts may be omitted, further acts may be added, and/or the order of the acts may be changed.

Method 400 starts at 401, for example in response to a call from another routine.

At 402, the digital processor computes the effective energies E of the integer variable of an input problem having n integer variables. The energies E(xᵢ) for an integer variable xᵢ are computed as a function of the magnitude of the integer and the current state of the other variables, according to EQ 9. The input problem may be received as part of a set of inputs at 401.

At 403, the digital processor computes the exponential weights wᵢⱼ for each variable xᵢ and all the cases j, according to EQ 10.

At 404, the digital processor computes the feasible region xᵢ^{max} for each integer variable xᵢ, according to EQ 13, where the feasible region xᵢ^{max} depends on constraint C.

At 405, the digital processor computes the mask Mⱼ for each variable xᵢ taking value j, according to EQ 14.

At 406, the digital processor computes the normalized probabilities pᵢⱼ that each variable xᵢ assumes the state j, in the feasible region only, where the probability of a variable xᵢ to assume state j is proportional to the exponential weights wₓ_{ᵢ} and to the mask M, according to EQ 15.

At 407, the digital processor obtains samples from the probability distribution pᵢⱼ computed at 406, for example by using Inverse Transform Sampling.

At 408, method 400 terminates, until it is, for example, invoked again.

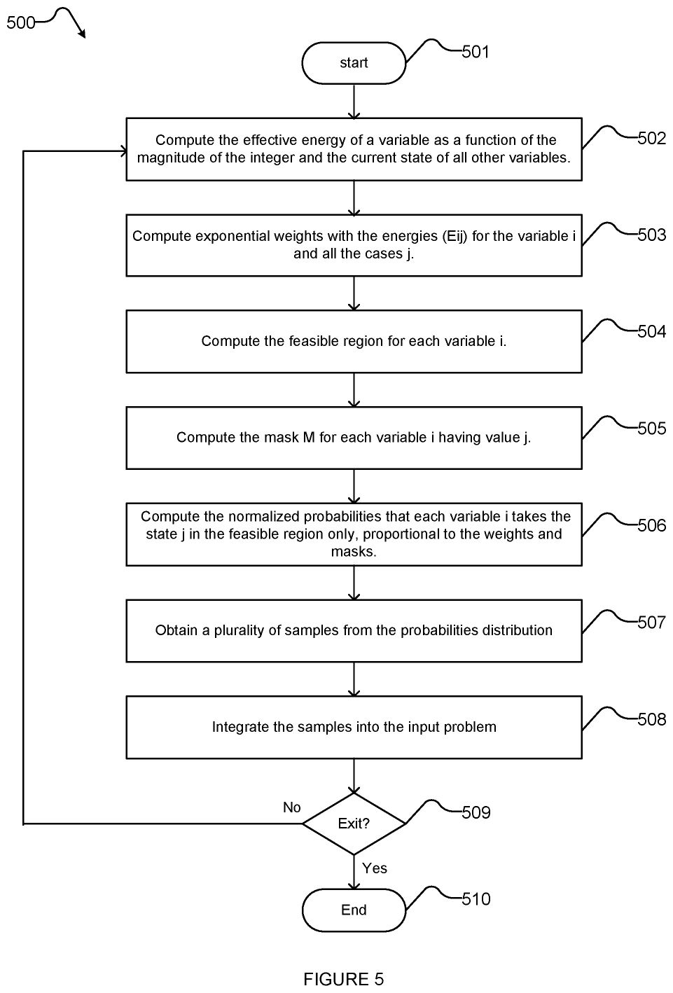

FIG. 5 is a flow diagram of an example iterative method 500 of operation of a computing system for sampling from the softmax distribution over cases of a categorical distribution with constraints. Method 500 may be executed on a hybrid computing system comprising at least one digital or classical processor and a quantum processor, for example hybrid computing system 100 of FIG. 1, or by a classical computing system comprising at least one digital or classical processor.

Method 500 comprises acts 501 to 510; however, a person skilled in the art will understand that the number of acts illustrated is an example, and, in some implementations, certain acts may be omitted, further acts may be added, and/or the order of the acts may be changed.

Method 500 starts at 501, for example in response to a call from another routine.

At 502, the digital processor computes the effective energies E of the integer variable of an input problem, as described above with reference to act 402 of method 400.

At 503, the digital processor computes the exponential weights wᵢⱼ for each variable xᵢ and all the cases j, according to EQ 10.

At 504, the digital processor computes the feasible region xᵢ^{max} for each integer variable xᵢ, according to EQ 13, where the feasible region xᵢ^{max} depends on constraint C.

At 505, the digital processor computes the mask Mⱼ for each variable xᵢ taking value j, according to EQ 14.

At 506, the digital processor computes the normalized probabilities pᵢⱼ that each variable xᵢ assumes the state j, in the feasible region only, where the probability of a variable xᵢ to assume state j is proportional to the exponential weights wₓ_{ᵢ} and to the mask M, according to EQ 15.

At 507, the digital processor obtains samples from the probability distribution pᵢⱼ computed at 506, for example using Inverse Transform Sampling.

At 508, the digital processor integrates samples obtained at 507 into the input problem of 502.

At 509, the digital processor checks if an exit condition has been met. If an exit condition has been met, control passes to 510, otherwise control passes to 502, where the effective energies E are computed again on the problem with the integrated samples. An exit condition may be a determination that a measure or a parameter representative of the quality of the variables is satisfied. An example of a measure of a quality of the variables is the energy of the variables. The determination may, for example, be based on an assessment of the variables, the assessment performed by the digital processor.

At 510 method 500 terminates, until it is, for example, invoked again.

Some classes of problems (e.g., problems with arbitrary variables) cannot be efficiently mapped to a quadratic unconstrained binary optimization (QUBO) problem or an Ising Hamiltonian problem. Thus, those problem require some overhead (e.g., conversion of variables) to be performed on a classical or digital processor to be then solved by a quantum computer. It is therefore desirable to efficiently solve arbitrary variables problems by efficiently mapping the problem to a model (e.g., a binary quadratic model) that can be then solved by a quantum computer. In the present disclosure and the appended claims, the term arbitrary variable is being used to denote continuous, discrete or binary variables.

The present disclosure describes systems and methods for solving problems having arbitrary variables with cross-Boltzmann updates using a hybrid computing system, for example hybrid computing system 100 of FIG. 1, comprising at least one classical or digital computer and a quantum computer. The at least one classical or digital computer uses cross-Boltzmann updates to build a binary problem that can be then solved by the quantum computer.

A problem may comprise a plurality of arbitrary variables v that can be continuous, discrete or binary. A digital computer may apply an algorithm to a problem with a plurality of arbitrary variables where an arbitrary variable vᵢ with old value vᵢ^{t-1} may be replaced by an updated value vᵢ^{t}. If vᵢ takes the update value (i.e., the update is accepted), then a binary variable sᵢ is equal a predetermined value (e.g. one). In the case of a simple update rule, the decision whether a variable vᵢ is updated is made independently of other variables in the plurality of variables of the problem. However, it is possible to compute the energy associated with updating two vᵢ and vⱼ as:

hᵢ=E(vᵢ^{t})−E(vᵢ^{t-1}) (16)

hⱼ=E(vⱼ^{t})−E(vⱼ^{t-1}) (17)

Jᵢⱼ=E(vᵢ^{t},vⱼ^{t})−E(vᵢ^{t-1},vⱼ^{t-1}) (18)

where hᵢ and hⱼ are the energy cost of individually updating variables vᵢ and vⱼ, respectively, and Jᵢⱼ is the energy cost of updating both variables together, or dependent on one another.

Then, the decision whether to update the variables vᵢ and vⱼ can be expressed through the Hamiltonian H:

$$H = {\sum }_{i} {h}_{i} {s}_{i} + {\sum }_{ij} {J}_{ij} {s}_{i} {s}_{j} \qquad ( 19 )$$

The binary variables sᵢ (e.g., factorial Bernoulli decisions)

sᵢ˜p(sᵢ|v^{t-1}) (20)

can be replaced with samples from the Boltzmann distribution:

$$s ∼ p ( s \vert {v}^{t - 1} ) = \frac{{e}^{- H ( s )}}{Z} \qquad ( 21 )$$

where Z represents the partition function.

For each non-binary variable vᵢ the digital processor can select two candidate values. The digital processor may use a native sampler in the space of integer or continuous variables to select the candidate values. In at least one implementation, the native sampler may be a Gibbs sampler. For example, the native sampler may return two independent samples X¹ and X². Then, the digital processor may define a new variable xᵢ, in terms of the binary variable sᵢ:

xᵢ=(Xᵢ¹−Xᵢ²)sᵢ+Xᵢ² (22)

Then, the input problem, an optimization problem in the space x, is turned into a search in the space s and can be sent to the quantum processor in this form:

minₓƒ(x)=minₛƒ((X¹−X²)s+X²) (23)

For discrete, non-binary, variables vᵢ, the problem can be converted to a Quadratic Unconstrained Binary Optimization (QUBO) problem in the following way. The energy function E is equivalent to a QUBO:

$$E = {\sum }_{ij} ( {h}_{i}^{j} - λ ) {x}_{i}^{j} + {\sum }_{ijkl} {J}_{ik}^{jl} {x}_{i}^{j} {x}_{k}^{l} + 2 λ {\sum }_{ijkl} {x}_{i}^{j} {x}_{k}^{l} + N λ \qquad ( 24 )$$

where λ is a coefficient of a penalty term and N is the number of variables.

EQ 24 above represents a discrete, non-binary, problem with constraints such that only one of the xᵢ^{j} can take the value one. Thus, a constraint binary optimization problem is relaxed to an unconstrained binary optimization problem using a penalty term with coefficient λ.

The above problem may be solved directly with a quantum processor, for example a quantum annealer, or via simulated classical annealing. However, solving EQ 24 directly may be inefficient due the large number of qubits per variable.

Instead of solving EQ 24 directly, a subproblem of the form of EQ 25 below can be solved by the quantum processor.

$$E = {\sum }_{i} ( {h}_{i}^{j} {x}_{i}^{j} + {h}_{i}^{{j}_{2}} {x}_{i}^{{j}_{2}} - λ ( {x}_{i}^{j} + {x}_{i}^{{j}_{2}} ) ) + {\sum }_{ik} ( {J}_{ik}^{jl} {x}_{i}^{j} {x}_{k}^{l} + {J}_{ik}^{{jl}_{2}} {x}_{i}^{j} {x}_{k}^{{l}_{2}} + {J}_{i k}^{{j}_{2} l} {x}_{i}^{{j}_{2}} {x}_{k}^{l} + {J}_{i k}^{{j}_{2} {l}_{2}} {x}_{i}^{{j}_{2}} {x}_{k}^{{l}_{2}} ) + 2 λ {\sum }_{i} {x}_{i}^{j} {x}_{i}^{{j}_{2}} + λ \qquad ( 25 )$$

where j₂ and l₂ are different values of variables j and l.

The problem of EQ 25 is similar to the input problem, but instead of summing over all possible values of variable x, the sum is over two of the values, selected by the digital processor with a native sampler. EQ 25 can be simplified by setting sᵢ=xᵢ^{j}^{₂}=1−xᵢ^{j}.

$$E = {\sum }_{i} {h}_{i}^{{j}_{2}} + {\sum }_{i k} {J}_{i k}^{{j}_{2} {l}_{2}} + {\sum }_{i} ( {h}_{i}^{j} - {h}_{i}^{{j}_{2}} + {\sum }_{k} ( {J}_{i k}^{{jl}_{2}} - {J}_{i k}^{{j}_{2} {l}_{2}} ) ) {s}_{i} + {\sum }_{i k} ( {J}_{i k}^{jl} - {J}_{i k}^{{jl}_{2}} - {J}_{i k}^{{j}_{2} l} + {J}_{i k}^{{j}_{2} {l}_{2}} ) {s}_{i} {s}_{k} \qquad ( 26 )$$

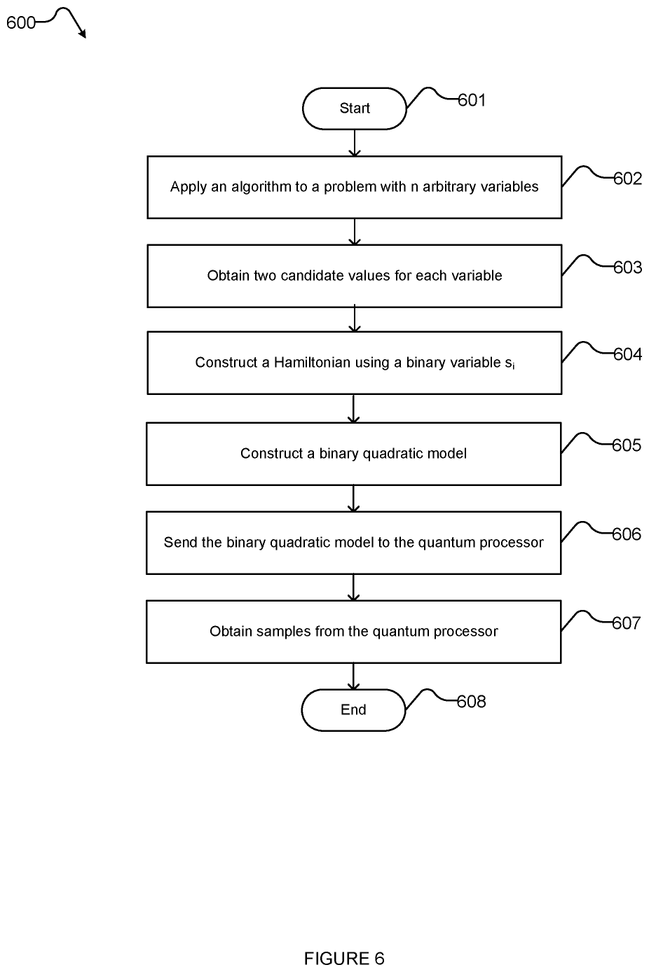

FIG. 6 is a flow diagram of an example method 600 of operation of a hybrid computing system using cross-Boltzmann updates. Method 600 may be executed on a hybrid computing system comprising at least one digital or classical processor and a quantum processor, for example hybrid computing system 100 of FIG. 1.

Method 600 comprises acts 601 to 608; however, a person skilled in the art will understand that the number of acts illustrated is an example, and, in some implementations, certain acts may be omitted, further acts may be added, and/or the order of the acts may be changed.

Method 600 starts at 601, for example in response to a call from another routine.

At 602, the digital processor applies an algorithm to an input problem having n arbitrary variables xᵢ. The n arbitrary variables may be continuous, discrete or binary variables. The input problem may be received at 601 as part of a set of inputs. The digital processor may apply a native solver, for example a Gibbs sampler, to the input problem.

At 603, the digital processor obtains two candidate values for each variable of the input problem, via the native solver applied at 602. The candidate values may be independent samples.

At 604, the digital processor constructs a Hamiltonian H of the problem using a binary value sᵢ, where sᵢ takes the value one if the variable vᵢ, having an old value v^{t-1}, assumes an update value v^{t}, and the Hamiltonian H depends on the binary variable s:

H=Σᵢhᵢsᵢ+ΣᵢⱼJᵢⱼsᵢsⱼ (19)

EQ 19 is introduced above and reproduced here for clarity. The details are explained above with reference to EQ 19.

At 605 the digital processor constructs a binary quadratic model of the problem from the Hamiltonian H of act 604. Depending on the nature of the arbitrary variables xᵢ, the digital processor contracts a binary quadratic model in a different way. For non-binary variables, a new variable xᵢ is defined in terms of sᵢ:

xᵢ=(Xᵢ¹−Xᵢ²)sᵢ+X² (22)

as described above in more detail at the first reference to EQ 22.

For discrete, non-binary variables, a subproblem E is constructed

$$E = {\sum }_{i} {h}_{i}^{{j}_{2}} + {\sum }_{i k} {J}_{i k}^{{j}_{2} {l}_{2}} + {\sum }_{i} ( {h}_{i}^{j} - {h}_{i}^{{j}_{2}} + {\sum }_{k} ( {J}_{i k}^{{jl}_{2}} - {J}_{i k}^{{j}_{2} {l}_{2}} ) ) {s}_{i} + {\sum }_{i k} ( {J}_{i k}^{jl} - {J}_{i k}^{{jl}_{2}} - {J}_{i k}^{{j}_{2} l} + {J}_{i k}^{{j}_{2} {l}_{2}} ) {s}_{i} {s}_{k} \qquad ( 26 )$$

as described above in more detail at the first reference to EQ 26.

At 606, the digital processor sends the binary quadratic model of 605 to the quantum processor. In at least one implementation, an embedding algorithm, for example a minor embedding, is applied to the model of act 605, generating an embedded problem that can be sent to the quantum processor. Examples of embedding techniques can be found in U.S. Pat. Nos. 7,984,012, 8,244,662, 9,727,823, 9,875,215, and 10,789,540.

At 607, the digital processor receives samples from the model sent at 605 generated by the quantum processor. The samples represent a solution to the input problem.

Method 600 terminates at 608, until it is, for example, invoked again.

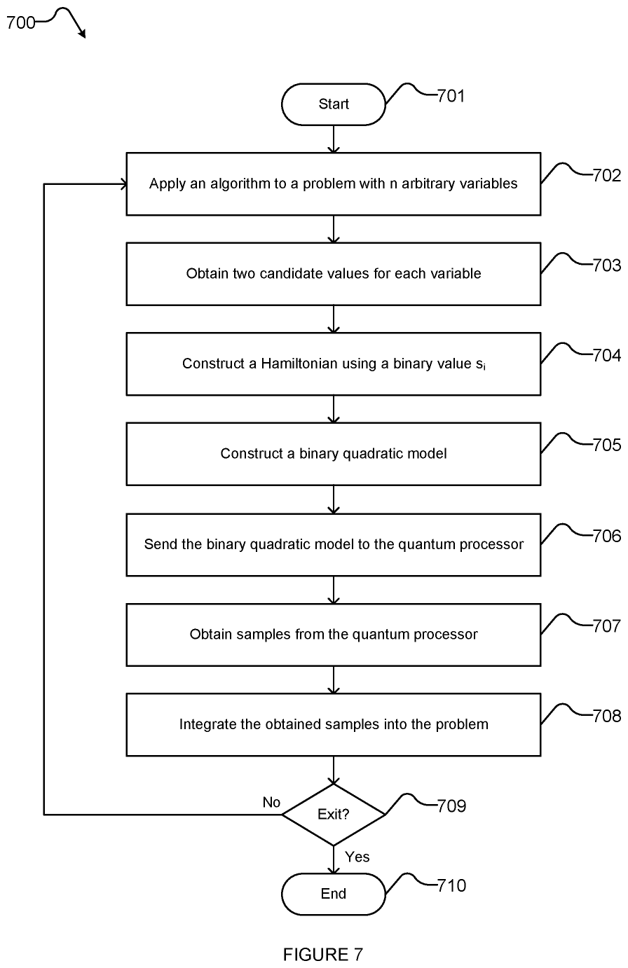

FIG. 7 is a flow diagram of an example iterative method 700 of operation of a hybrid computing system using cross-Boltzmann updates. Method 700 may be executed on a hybrid computing system comprising at least one digital or classical processor and a quantum processor, for example hybrid computing system 100 of FIG. 1.

Method 700 comprises acts 701 to 710; however, a person skilled in the art will understand that the number of acts illustrated is an example, and, in some implementations, certain acts may be omitted, further acts may be added, and/or the order of the acts may be changed.

Method 700 starts at 701, for example in response to a call from another routine.

At 702, the digital processor applies an algorithm to an input problem having n arbitrary variables xᵢ, as described above with reference to act 602 of method 600.

At 703, the digital processor obtains two candidate values for each variable of the input problem, as described above with reference to act 603 of method 600.

At 704, the digital processor constructs a Hamiltonian H of the problem using a binary value sᵢ, as described above with reference to act 604 of method 600.

At 705, the digital processor constructs a binary quadratic model of the problem from the Hamiltonian H of act 704, as described above with reference to act 605 of method 600.

At 706, the digital processor sends the binary quadratic model to the quantum processor, as described above with reference to act 606 of method 600.

At 707, the digital processor receives samples from the model sent at 706 generated by the quantum processor.

At 708, the digital processor integrates the samples received at 707 into the input problem.

At 709, the digital processor checks if an exit condition has been met. If an exit condition has been met, control passes to 710, otherwise control passes to 702, where the digital processor again applies an algorithm to the input problem with the integrated samples. An exit condition may be a determination that a measure or a parameter representative of the quality of the variables is satisfied. An example of a measure of a quality of the variables is the energy of the variables. The determination may, for example, be based on an assessment of the variables, the assessment performed by the digital processor.

At 710 method 700 terminates, until it is, for example, invoked again.

Method 600 and 700 may also be applied when solving problems that may benefit from obtaining samples from a categorical distribution, for example the problem of optimizing a protein structure, as described above with reference to method 200 of FIG. 2 and method 300 of FIG. 3.

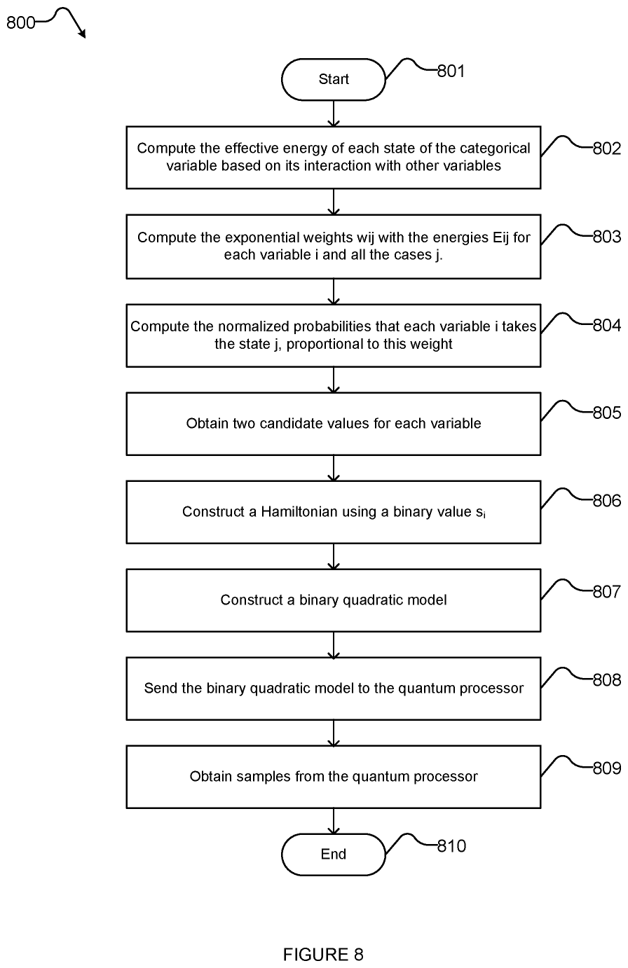

FIG. 8 is a flow diagram of an example method 800 of operation of a hybrid computing system for sampling from the softmax distribution over cases of a categorical distribution and using cross-Boltzmann updates. Method 800 may be executed on a hybrid computing system comprising at least one digital or classical processor and a quantum processor, for example hybrid computing system 100 of FIG. 1.

Method 800 comprises acts 801 to 810; however, a person skilled in the art will understand that the number of acts illustrated is an example, and, in some implementations, certain acts may be omitted, further acts may be added, and/or the order of the acts may be changed.

Method 800 starts at 801, for example in response to a call from another routine.

At 802, the digital processor computes the effective energies E(xᵢ^{j}) of an input problem having n categorical variables. The energies E(xᵢ^{j}) (EQ 6) are computed for each state j=1, . . . , Dᵢ of the categorical variable xᵢ, i=1, . . . , n, based on its interaction with other variables. The problem may be received as part of a set of inputs at 801.

At 803, the digital processor computes the exponential weights wᵢⱼ (EQ 7) for all the cases j of the variable xᵢ.

At 804, the digital processor computes the normalized probabilities pᵢⱼ (EQ 8) that each variable i takes the state j, proportional to the weights wᵢⱼ computed at 803.

At 805, the digital processor obtains two candidate values for each variable of the input problem, via sampling from the probabilities computed at 804. The candidate values may be independent samples.

At 806, the digital processor constructs a Hamiltonian H of the problem using a binary value sᵢ, where sᵢ takes the value one if the variable vᵢ, having an old value v^{t-1}, assumes an update value v^{t}, and the Hamiltonian H depends on the binary variable s:

$$H = {\sum }_{i} {h}_{i} {s}_{i} + {\sum }_{ij} {J}_{ij} {s}_{i} {s}_{j} \qquad ( 19 )$$

as explained above at the first reference to EQ 19.

At 807, the digital processor constructs a binary quadratic model of the problem from the Hamiltonian H of act 806. Depending on the nature of the arbitrary variables, the digital processor contracts a binary quadratic model in a different way, as described above with reference to act 605 of method 600.

At 808, the digital processor sends the binary quadratic model to the quantum processor. In at least one implementation, an embedding algorithm, for example a minor embedding, is applied to the model of act 807, generating an embedded problem that can be sent to the quantum processor.

At 809, the digital processor receives samples from the model sent at 808 generated by the quantum processor. The samples represent a solution to the input problem.

At 810, method 800 terminates, until it is, for example, invoked again.

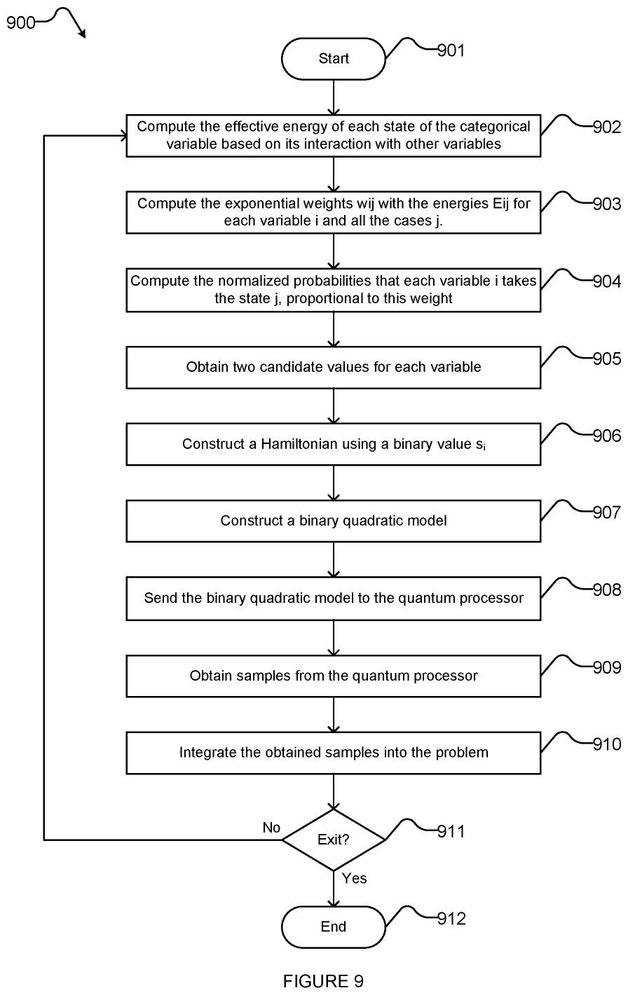

FIG. 9 is a flow diagram of an example iterative method of operation 900 of a hybrid computing system for sampling from the softmax distribution over cases of a categorical distribution and using cross-Boltzmann updates. Method 900 may be executed on a hybrid computing system comprising at least one digital or classical processor and a quantum processor, for example hybrid computing system 100 of FIG. 1.

Method 900 comprises acts 901 to 912; however, a person skilled in the art will understand that the number of acts illustrated is an example, and, in some implementations, certain acts may be omitted, further acts may be added, and/or the order of the acts may be changed.

Method 900 starts at 901, for example in response to a call from another routine.

At 902, the digital processor computes the effective energies E(xᵢ^{j}) of an input problem having n categorical variables, as described above with reference to act 802 of method 800.

At 903, the digital processor computes the exponential weights wᵢⱼ (EQ 7) for all the cases j of the variable xᵢ.

At 904, the digital processor computes the normalized probabilities pᵢⱼ (EQ 8) that each variable i takes the state j, proportional to the weights wᵢⱼ computed at 903.

At 905, the digital processor obtains two candidate values for each variable of the input problem, via sampling from the probabilities computed at 904. The candidate values may be independent samples.

At 906, the digital processor constructs a Hamiltonian H of the problem using a binary value sᵢ, as described above with reference to act 806 of method 800.

At 907, the digital processor constructs a binary quadratic model of the problem from the Hamiltonian H of act 906, as described above with reference to act 807 of method 800.

At 908, the digital processor sends the binary quadratic model to the quantum processor. In at least one implementation, an embedding algorithm, for example a minor embedding, is applied to the model of act 907, generating an embedded problem that can be sent to the quantum processor.

At 909, the digital processor receives samples from the model sent at 908 generated by the quantum processor. The samples represent a solution to the input problem.

At 910, the digital processor integrates the samples received at 909 into the input problem of 902.

At 911, the digital processor checks if an exit condition has been met. If an exit condition has been met, control passes to 912, otherwise to 902, where the digital processor again computes the effective energies E(xᵢ^{j}) of the input problem with the integrated samples. An exit condition may be a determination that a measure or a parameter representative of the quality of the variables is satisfied. An example of a measure of a quality of the variables is the energy of the variables. The determination may, for example, be based on an assessment of the variables, the assessment performed by the digital processor.

At 912, method 900 terminates, until it is, for example, invoked again.

Method 800 and 900 may be applied when solving constraint problems that may benefit from obtaining samples from a categorical distribution, for example constraint quadratic integer problems, as described above with reference to method 400 of FIG. 4 and method 500 of FIG. 5.

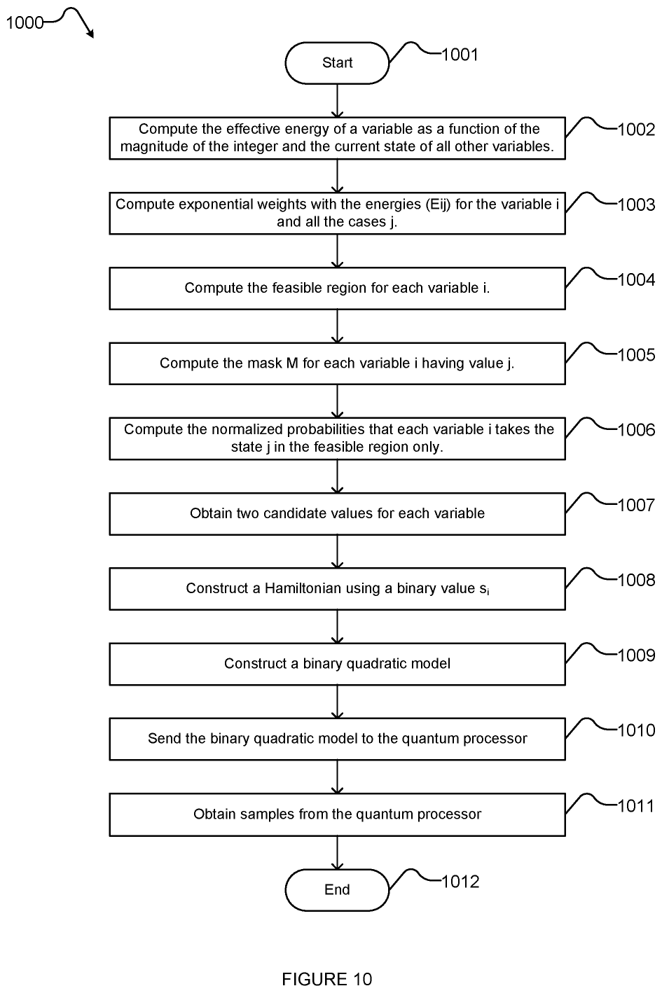

FIG. 10 is a flow diagram of an example method 1000 of operation of a hybrid computing system for sampling from the softmax distribution over cases of a categorical distribution using constraints and using cross-Boltzmann updates. Method 1000 may be executed on a hybrid computing system comprising at least one digital or classical processor and a quantum processor, for example hybrid computing system 100 of FIG. 1.

Method 1000 comprises acts 1001 to 1012; however, a person skilled in the art will understand that the number of acts illustrated is an example, and, in some implementations, certain acts may be omitted, further acts may be added, and/or the order of the acts may be changed.

Method 1000 starts at 1001, for example in response to a call from another routine.

At 1002, the digital processor computes the effective energies E of the integer variables of an input problem having n integer variables. The energies E(xᵢ) for an integer variable xᵢ are computed as a function of the magnitude of the integer and the current state of the other variables, according to EQ 9. The input problem may be received as part of a set of inputs at 1001.

At 1003, the digital processor computes the exponential weights wᵢⱼ for each variable xᵢ and all the cases j, according to EQ 10.

At 1004, the digital processor computes the feasible region xᵢ^{max} for each integer variable xᵢ, according to EQ 13, where the feasible region depends on constraint C.

At 1005, the digital processor computes the mask Mⱼ for each variable xᵢ having value j, according to EQ 14.

At 1006, the digital processor computes the normalized probabilities pᵢⱼ that each variable xᵢ assumes the state j, in the feasible region only, where the probability of a variable xᵢ to assume state j is proportional to the exponential weights wₓ_{ᵢ} and to the mask M, according to EQ 15.

At 1007, the digital processor obtains two candidate values for each variable of the input problem, via sampling from the probabilities computed at 1006. The candidate values may be independent samples.

At 1008, the digital processor constructs a Hamiltonian H of the problem using a binary value sᵢ, where sᵢ takes the value one if the variable vᵢ, having an old value v^{t-1}, assumes an update value v^{t}, and the Hamiltonian H depends on the binary variable s,

$$H = {\sum }_{i} {h}_{i} {s}_{i} {\sum }_{ij} {J}_{ij} {s}_{i} {s}_{j} \qquad ( 19 )$$

as explained above at the first reference to EQ 19.

At 1009, the digital processor constructs a binary quadratic model of the problem from the Hamiltonian H of act 1008. Depending on the nature of the variables xᵢ, the digital processor contracts a binary quadratic model in a different way, as described above with reference to act 605 of method 600.

At 1010, the digital processor sends the binary quadratic model to the quantum processor. In at least one implementation, an embedding algorithm, for example a minor embedding, is applied to the model of act 1009, generating an embedded problem that can be sent to the quantum processor.

At 1011, the digital processor receives samples from the model sent at 1010 generated by the quantum processor. The samples represent a solution to the input problem.

At 1012, method 1000 terminates, until it is, for example, invoked again.

FIG. 11 is a flow diagram of an example iterative method 1100 of operation of a hybrid computing system for sampling from the softmax distribution over cases of a categorical distribution using constraints and cross-Boltzmann updates. Method 1100 may be executed on a hybrid computing system comprising at least one digital or classical processor and a quantum processor, for example hybrid computing system 100 of FIG. 1.

Method 1100 comprises acts 1101 to 1114; however, a person skilled in the art will understand that the number of acts illustrated is an example, and, in some implementations, certain acts may be omitted, further acts may be added, and/or the order of the acts may be changed.

Method 1100 starts at 1101, for example in response to a call from another routine.

At 1102, the digital processor computes the effective energies E of the integer variables of an input problem having n integer variables, as described above with reference to act 1002 of method 1000.

At 1103, the digital processor computes the exponential weights wᵢⱼ for each variable xᵢ and all the cases j, according to EQ 10.

At 1104, the digital processor computes the feasible region xᵢ^{max} for each integer variable xᵢ, according to EQ 13, where the feasible region depends on constraint C.

At 1105, the digital processor computes the mask Mⱼ for each variable xᵢ having value j, according to EQ 14.

At 1106, the digital processor computes the normalized probabilities pᵢⱼ that each variable xᵢ assumes the state j, in the feasible region only, where the probability of a variable xᵢ assuming state j is proportional to the exponential weights wₓ_{ᵢ} and to the mask M, according to EQ 15.

At 1107, the digital processor obtains two candidate values for each variable of the input problem via sampling from the probabilities computed at 1106. The candidate values may be independent samples.

At 1108, the digital processor constructs a Hamiltonian H of the problem using a binary value sᵢ, as described above with reference to act 1008 of method 1000.

At 1109, the digital processor constructs a binary quadratic model of the problem from the Hamiltonian H of act 1108, as described above with reference to act 1009 of method 1000.

At 1110, the digital processor sends the binary quadratic model of act 1109 to the quantum processor, as described above with reference to act 1010 of method 1000.

At 1111, the digital processor receives samples from the model sent at 1110 generated by the quantum processor. The samples represent a solution to the input problem.

At 1112, the digital processor integrates the samples received at 1111 into the input problem.

At 1113, the digital processor checks if an exit condition has been met. If an exit condition has been met, control passes to 1114, otherwise control passes to 1102, where the digital processor again computes the effective energies E(xᵢ^{j}) of the input problem with the integrated samples. An exit condition may be a determination that a measure or a parameter representative of the quality of the variables is satisfied. An example of a measure of a quality of the variables is the energy of the variables. The determination may, for example, be based on an assessment of the variables, the assessment performed by the digital processor.

At 1114, method 1100 terminates, until it is, for example, invoked again.

The systems and methods described above can be used to optimize resource scheduling, for example scheduling equipment and/or personnel for a job assignment at a location. Resource scheduling is an NP-hard problem and can be formulated, for example, as a linear integer program. Linear integer programs may be solved with commercially available software, for example, SCIP Solver, CPLEX® Optimizer or Gurobi® Optimizer. However, formulating resource scheduling as integer linear programming introduces binary variables to enforce logical constraints, thereby increasing the complexity, and thus the computation time required to solve the resource scheduling problem. A long computation time may entail that a resource manager spends a large amount of time allocating resources to, for example, jobs or shifts or locations, increasing inefficiency in a business.

Resource scheduling can be formulated as a discrete quadratic model ƒ that encodes one-hot constraints and then solved on a quantum processor. Such a model can be thought of as a binary quadratic model with one-hot constraints, as explained above with reference to EQ 19:

$$f = {\sum }_{ij} {h}_{ij} {x}_{ij} + {\sum }_{ijkl} {Q}_{ijkl} {x}_{ij} {x}_{k l} \qquad ( 27 )$$

Where Σⱼxᵢⱼ=1, xᵢⱼ∈{0,1}, and hᵢⱼ and Qᵢⱼₖₗ are linear and quadratic biases, respectively.

The variable x_{d,i} can be defined for each resource i and each day d. Resources can be available to start at various times, for various durations, and in different departments and locations. Of all the combinations of these attributes, only one option can be selected at a time. For example, x_{(d,i),(s,u,j,l)} indicates that on day d, resource i will start at time s, for u hours, in department j, at location l. Given that the above formulation only considers start times, it is not possible that any of the available combinations of time, hours, department and location described happen at the same time.

$${\sum }_{( s , u , j , l ) ∈ {S}_{d , i}} {x}_{( d , i ) , ( s , u , j , l )} \leq 1 \qquad ( 28 )$$

Where S_{d,i}={(s,u,j,l) if A_{d,i,s,u,j,l}=1} is the set of attributes (s,u,j,l) for which a resource is available, and A is the availability of resource i on day d at start time s, for u hours, in department j at location l.

By augmenting the set S_{d,i} with the case 0, which indicates a case is not selected, the inequality above can be converted to an equality.

$${\sum }_{( s , u , j , l ) ∈ {S}_{d , i} + \{ 0 \}} {x}_{( d , i ) , ( s , u , j , l )} = 1 \qquad ( 29 )$$

In some implementations, it is desirable to schedule certain resources (e.g., more efficient resources, newer resources . . . ) to certain jobs, shifts, or locations, and to do so without introducing new variables to avoid increasing the complexity of the problems. The resource scheduling problem can be optimized by biasing individual resources.

$${f}_{0} = {\sum }_{( d , i ) , ( s , u , j , l )} {α}_{( i )} {x}_{( d , i ) , ( s , u , j , l )} \qquad ( 30 )$$

Where the function ƒ₀ imposes a bias on which resource i is scheduled on day d, for a start s, for u hours, in department j and location l, and α represents the bias.

Demand for resources can be optimized by minimizing the distance between scheduled hours and the required hours for every day, time, department and location. The function ƒ₁ minimizes the distance between the scheduled resources and the demands for resources.

$${f}_{1} = {\sum }_{d , b , j , l} {( {\sum }_{i , ( s , u ) ∈ {S}_{b}} {x}_{( d , i ) , ( s , u , j , l )} - {R}_{d , b , j , l} )}^{2} \qquad ( 31 )$$

Where b is the time bin, S_{b}={(s,u):s≤b<s+u} is the set of starts s and hours u that overlap in a bin b, and R_{d,b,j,l} is the demand for resources on a day d, for a time bin b, in a department j in a location l.

It may also be desirable to add another objective function ƒ₂ to the problem to ensure that each resource is allotted a certain number of hours u. Function ƒ₂ minimizes the distance between the scheduled hours and the planned hours, where Sᵢ is the set of planned hours.

$${f}_{2} = {\sum }_{i} {( {\sum }_{d , su , j , l} u {x}_{( d , i ) , ( s , u , j , l )} - {S}_{i} )}^{2} \qquad ( 32 )$$

In some implementations, it may be desirable to add another objective function ƒ₃ to ensure that a given resource is scheduled for a period of inactivity (e.g., two consecutive days of inactivity), here represented by a 0 (i.e., not scheduled). In certain implementations it may be desirable to schedule two consecutive days off, e.g., for scheduled maintenance.

$${f}_{3} = - {\sum }_{d , i} {x}_{( d , i ) , ( 0 )} {x}_{( d + 1 , i ) , ( 0 )} \qquad ( 33 )$$

$$and$$

$${\sum }_{d , i} {x}_{( d , i ) , ( 0 )} \geq 2 \qquad ( 34 )$$

The following is an example set of constraints that can be applied to the resource scheduling problem. However, a person skilled in the art will understand that the below set of constraints is for example purposes only and some constraints may not be used, and other constraints may be added:

Each resource is assigned hours of work based on the resource availability.

Shifts length can vary, for example depending on the type of assignment or location.

The time between two consecutive shifts may vary, for example depending on the distance between the physical location of two consecutive shifts or depending on equipment scheduled maintenance. In one example implementation, a time between shifts for a resource may be at least 15 hours.

$${f}_{gap} = {\sum }_{d , i , j , l , {j}^{′} , {l}^{′} , {u}^{′}} {\sum }_{( s , u , {s}^{′} ) ∈ {S}_{δ t}} {x}_{( d , i ) , ( s , u , j , l )} {x}_{( d + 1 , i ) , ( {s}^{′} , {u}^{′} , {j}^{′} , {l}^{′} )} where \\ {S}_{δ t} = \{ ( s , u , {s}^{′} ) : {t}_{{s}^{′}} - {t}_{s , u} \leq {t}_{gap} \} . \qquad ( 35 )$$

Each resource is assigned hours close to the number of hours planned.

Each resource may be allocated a scheduled period of inactivity. For example, equipment may be idle one day a week or two consecutive days a week due to scheduled weekly maintenance.

Each department is assigned resources closed to the required number of resources, per day, and per week.

Multiple department or locations can be optimized together, sharing the same resources.

The binary quadratic model constructed with the above mentioned constraints can then be solved using a hybrid computing system, for example hybrid computing system 100 of FIG. 1, using any of the methods 600, 700, 800, 900, 1000 and 1100 of FIGS. 6, 7, 8, 9, 10 and 11, respectively.

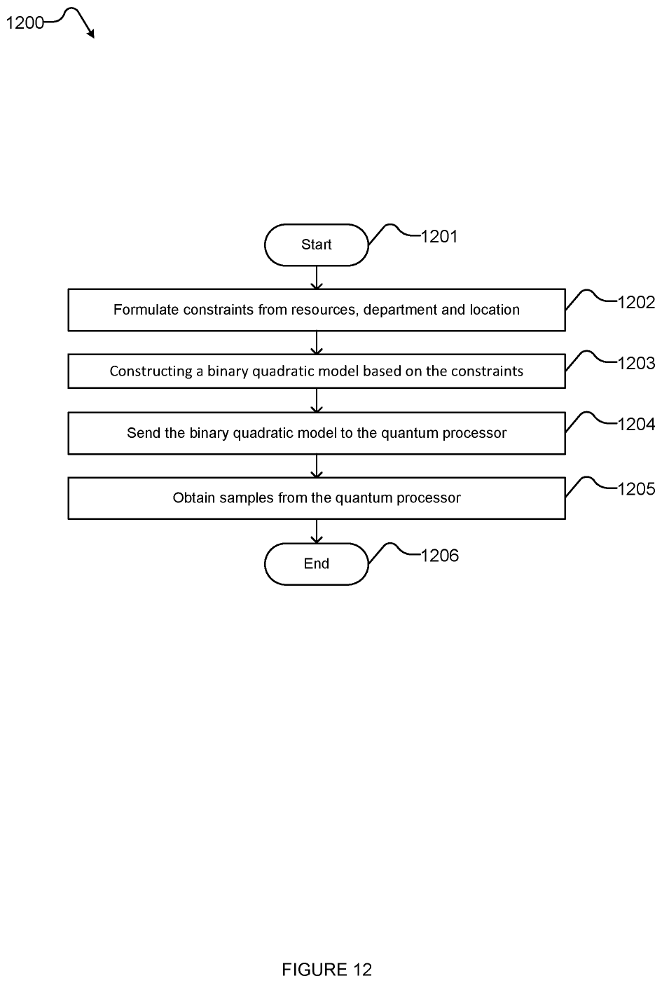

FIG. 12 is a flow diagram of an example method 1200 of operation of a hybrid computing system for optimizing resource scheduling. Method 1200 may be executed on a hybrid computing system comprising at least one digital or classical processor and a quantum processor, for example hybrid computing system 100 of FIG. 1.

Method 1200 comprises acts 1201 to 1206; however, a person skilled in the art will understand that the number of acts illustrated is an example, and, in some implementations, certain acts may be omitted, further acts may be added, and/or the order of the acts may be changed.

Method 1200 starts at 1201, for example in response to a call from another routine. Method 1200 may take as a set of input data about each resource, for example planned availability and planned period of inactivity, and data about each work department and location, for example required resources.

At 1202, the digital processor formulates the input data into a set of constraints for each resource, day, time, department and location. In at least one implementation, the digital processor formulates the following constraints: each resource is assigned hours of work based on the resource availability; shifts length can vary, for example depending on the type of assignment or location; the time between two consecutive shifts may vary, for example depending on the distance between the physical location of two consecutive shifts or depending on equipment scheduled maintenance; each resource is assigned hours close to the number of hours planned. Each resource may be allocated a scheduled period of inactivity; each department is assigned resources closed to the required number of resources, per day, and per week.

At 1203, the digital processor constructs a binary quadratic model based on the set of constraints formulated at 1202. The digital processor may employ any of the methods 600, 700, 800, 900, 1000 and 1100 of FIGS. 6, 7, 8, 9, 10 and 11, respectively.

At 1204, the digital processor sends the binary quadratic model constructed at 1203 to the quantum processor. In at least one implementation, an embedding algorithm, for example a minor embedding, is applied to the model of act 1203, generating an embedded problem that can be sent to the quantum processor.

At 1205, the digital processor receives samples from the model sent at 1204 generated by the quantum processor. The samples represent a solution to the input problem.

At 1206, method 1200 terminates, until it is, for example, invoked again.

The above described method(s), process(es), or technique(s) could be implemented by a series of processor readable instructions stored on one or more nontransitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for example purposes only and may change in alternative examples. Some of the example acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the example methods for quantum computation generally described above.

The various implementations described above can be combined to provide further implementations. All of the commonly assigned US patent application publications, US patent applications, foreign patents, and foreign patent applications referred to in this specification and/or listed in the Application Data Sheet are incorporated herein by reference, in their entirety, including but not limited to: U.S. Pat. No. 7,533,068; U.S. Patent Publication No. 20200234172; U.S. Pat. Nos. 7,984,012; 8,244,662; 9,727,823; 9,875,215; 10,789,540; and U.S. Provisional Patent Application No. 62/951,749.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method of computation in a processor-based system, the method comprising:
applying an algorithm to a problem with n arbitrary variables vᵢ;
obtaining two candidate values for each arbitrary variable vᵢ from the algorithm;
constructing a Hamiltonian that uses a binary value sᵢ to determine which of the two candidate values each arbitrary variable vᵢ should take;
constructing a binary quadratic model based on the Hamiltonian; and
obtaining samples from the binary quadratic model from a quantum processor as a solution to the problem.

2. The method of claim 1 wherein applying an algorithm to a problem with n arbitrary variables vᵢ includes applying a Gibbs sampler to a problem with n arbitrary variables vᵢ; and obtaining two candidate values for each arbitrary variable vᵢ from the algorithm includes obtaining two candidate values for each arbitrary variable vᵢ from the Gibbs sampler.

3. The method of claim 1 wherein applying an algorithm to a problem with n arbitrary variables vᵢ includes:
for each of the arbitrary variables, computing an energy of each state of the arbitrary variable based on an interaction of the arbitrary variable with other ones of the arbitrary variables;
for each of the arbitrary variables, computing a respective exponential weight for the arbitrary variable for each of a number Dᵢ of distinct values of the arbitrary variable; and
computing normalized probabilities that each arbitrary variable takes one of the values Dᵢ, proportional to the exponential weights.

4. The method of claim 1 wherein applying an algorithm to a problem with n arbitrary variables vᵢ includes:
for each of the arbitrary variables, computing an energy of the arbitrary variable as a function of a magnitude of the arbitrary variable and a current state of all of the other ones of the arbitrary variables;
for each of the arbitrary variables, computing a respective exponential weight for the arbitrary variable for each of a respective number Dᵢ of distinct values of the arbitrary variable;
for each of the arbitrary variables, computing a feasible region for the arbitrary variable, the feasible region comprising a set of values that respect a set of constraints;
for each of the arbitrary variables, computing a mask for the arbitrary variable at each of the respective number Dᵢ of distinct values; and
for each of the arbitrary variables, computing normalized probabilities that collectively represent a probability that the arbitrary variable takes one of the respective number Dᵢ of distinct values of the arbitrary variable, proportional to the exponential weights and the mask.

5. The method of any one of claims 1 through 4, wherein constructing a binary quadratic model includes defining a new variable xᵢ in terms of sᵢ and the two candidate values and converting the problem to an optimization problem in the space of sᵢ.

6. The method of any one of claims 1 through 4, wherein constructing a binary quadratic model includes relaxing a constrained binary optimization problem into an unconstrained binary optimization problem using a penalty term; and summing over the two candidate values.

7. The method of any one of claims 1 through 4, further comprising applying an embedding algorithm to the binary quadratic model to define an embedding on the quantum processor before obtaining samples from the binary quadratic model from the quantum processor.

8. The method of claim 1 further comprising:
iteratively repeating until an exit condition is met:
applying an algorithm to a problem with n arbitrary variables vᵢ;
obtaining two candidate values for each arbitrary variable vᵢ from the algorithm;
constructing a Hamiltonian that uses a binary value sᵢ to determine which of the two candidate values each arbitrary variable vᵢ should take;
constructing a binary quadratic model based on the Hamiltonian;
obtaining samples from the binary quadratic model from the quantum processor; and
integrating the samples into the problem.

9. The method of claim 8 further comprising determining whether an exit condition has been met.

10. The method of claim 9 wherein determining whether an exit condition has been met includes determining whether a measure representative of a quality assessment of the arbitrary variables is satisfied.

11. The method of any one of claims 1 through 4, wherein the problem is a resource scheduling problem.

12. A processor-based system, comprising at least one classical processor, the system operable to perform any of the methods of claims 1 through 11.

13. The processor-based system of claim 12, further comprising a quantum processor communicatively coupled to the at least one classical processor.

14. A method of operation in a processor-based system to compute a softmax distribution of an input problem having n variables, each variable taking a respective number Dᵢ of distinct values, the method comprising:
for each variable of the input problem, computing an energy of each state of the variable of the input problem based in an interaction of the respective variable with other ones of the variables;
for each variable of the input problem, computing respective exponential weights for the variable at each of the respective number Dᵢ of distinct values of the variable;
for each variable of the input problem, computing normalized probabilities that collectively represent a probability that the variable takes one of the respective number Dᵢ of distinct values of the variable, proportional to the exponential weights; and
obtaining a plurality of samples from the number of normalized probabilities.

15. The method of claim 14 wherein obtaining a plurality of samples from the normalized probabilities includes obtaining a plurality of samples from the normalized probabilities via Inverse Transform Sampling.

16. The method of claim 14 wherein computing an energy of each state of the variable for each variable of the input problem includes computing an energy of each state of each variable of a protein side-chain optimization problem.

17. The method of claim 14 further comprising:
iteratively repeating until an exit condition is met:
for each variable of the input problem, computing an energy of each state of the variable based an interaction of the respective variable with other ones of the variables;
for each variable of the input problem, computing a respective number of exponential weights for the variable at each of the respective number Dᵢ of distinct values of the variable;
for each variable of the input problem, computing normalized probabilities that collectively represent a probability that the variable takes one of the respective number Dᵢ of distinct values of the variable, proportional to the exponential weights;
obtaining a plurality of samples from the normalized probabilities; and
integrating the plurality of samples into the input problem.

18. The method of claim 17 further comprising determining whether an exit condition has been met.

19. The method of claim 18 wherein determining whether an exit condition has been met includes determining whether a measure representative of a quality assessment of the variables is satisfied.

20. A processor-based system, comprising at least one classical processor, the processor-based system operable to execute any of the methods of claims 14 through 19.

21. A method of operation in a processor-based system to compute a softmax distribution of an input problem having n variables, each variable taking a respective number Dᵢ of distinct values, the method comprising:
for each variable of the input problem, computing an energy of the variable of the input problem as a function of a magnitude of the variable and a current state of all other ones of the variables;
for each variable of the input problem, computing a number of exponential weights for the variable at each of the respective number Dᵢ of distinct values of the variable;
for each variable of the input problem, computing a feasible region for the variable, the feasible region comprising a set of values that respect a set of constraints;
for each variable of the input problem, computing a mask for the variable at each of the respective number Dᵢ of distinct values of the variable;
for each variable of the input problem, computing a number of normalized probabilities that represent a probability that the variable takes one of the respective number Dᵢ of distinct values of the variable, proportional to the exponential weights and the mask; and
obtaining a plurality of samples from the number of normalized probabilities.

22. The method of claim 21 wherein computing an energy of the variable for each variable of the input problem includes computing an energy of each variable of a constraint quadratic integer problem.

23. The method of claim 21 wherein obtaining a plurality of samples from the number of normalized probabilities includes obtaining a plurality of samples from the number of normalized probabilities via Inverse Transform Sampling.

24. The method of claim 21, further comprising:
iteratively repeating until an exit condition is met:
for each variable of the input problem, computing an energy of the variable of the input problem as a function of a magnitude of the variable and a current state of all the other ones of the variables;
for each variable of the input problem, computing a respective number of exponential weights for the variable at each of the respective number Dᵢ of distinct values of the variable;
for each variable of the input problem, computing a feasible region for the variable, the feasible region comprising a set of values that respect a set of constraints;
for each variable of the input problem, computing a mask for the variable at each of the respective number Dᵢ of distinct values of the variable;
for each variable of the input problem, computing a number of normalized probabilities that the variable takes one of the respective number Dᵢ of distinct values of the variable, proportional to the exponential weights and the mask;
obtaining a plurality of samples from the normalized probabilities; and
integrating the plurality of samples into the input problem.

25. The method of claim 24, further comprising determining whether an exit condition has been met.

26. The method of claim 25 wherein determining whether an exit condition has been met includes determining whether a measure representative of a quality assessment of the variables is satisfied.

27. A processor-based system, comprising at least one classical processor, the processor-based system operable to execute any of the methods of claims 21 through 26.
